(19) United States
(12) Patent Application Publication
(10) Pub. No.: US 2024/0311406 A1
(43) Pub. Date: Sep. 19, 2024

(54) DATA EXTRACTION AND ANALYSIS FROM UNSTRUCTURED DOCUMENTS

(71) Applicant: ADOBE INC., SAN JOSE, CA (US)

(72) Inventors: Arpit Narechania, Atlanta, GA (US); Fan Du, Milpitas, CA (US); Atanu Sinha, Kodbisanahalli (IN); Nedim Lipka, Campbell, CA (US); Alexa F. Siu, Sunnyvale, CA (US); Jane Elizabeth Hoffswell, Seattle, WA (US); Eunyee Koh, Sunnyvale, CA (US); Vasanthi Holtcamp, Fremont, CA (US)

(21) Appl. No.: 18/482,754

(22) Filed: Oct. 6, 2023

Related U.S. Application Data
(63) Continuation-in-part of application No. 18/185,547, filed on Mar. 17, 2023.

(51) Int. Cl. G06F 16/332; G06F 16/338; G06F 40/205

(52) U.S. Cl. CPC G06F 16/3329; G06F 16/338; G06F 40/205

(57) ABSTRACT

Aspects of a method, apparatus, non-transitory computer readable medium, and system include obtaining a document and a query. A plurality of data elements are identified from the document by locating a plurality of corresponding flexible anchor elements. Then, the data elements are extracted based on the plurality of flexible anchor elements. Content including an analysis of the extracted data elements based on the query is generated.

### CROSS-REFERENCE TO RELATED APPLICATION

This application claims the benefit under 35 U.S.C. 120 to U.S. patent application Ser. No. 18/185,547, to Arpit Narechania, et al., filed on Mar. 17, 2023, the entire contents of which is expressly incorporated herein by reference.

### BACKGROUND

The following relates to data extraction and analysis from semi-structured or unstructured documents. Many documents have a particular structure that can be used to automatically identify and extract information. For example, a document might contain text, tables, images and other graphical elements, as well as informal relationships among document elements. Different software applications, such as spreadsheet applications, can perform calculations on provided data, but involve transferring and transforming data from other document formats.

### SUMMARY

Embodiments of the present disclosure provide an analysis functionality that can use previously extracted data from unstructured or semi-structured documents utilizing the same software. This can avoid switching from one software application to another application and manually copying over the extracted data, which can be inconvenient for a user.

A method, apparatus, non-transitory computer readable medium, and system for data analysis are described. One or more aspects of the method, apparatus, non-transitory computer readable medium, and system include obtaining a document and a query; identifying, from the document, a plurality of data elements based on the query using a plurality of flexible anchor elements, respectively; extracting the plurality of data elements corresponding to the query based on the plurality of flexible anchor elements; and generating content including an analysis of the extracted data elements based on the query.

A method, apparatus, non-transitory computer readable medium, and system for data extraction are described. One or more aspects of the method, apparatus, non-transitory computer readable medium, and system include identifying a plurality of documents for data extraction to a machine learning model trained to identify data elements. The aspects further include identifying one or more data elements in at least one of the plurality of documents, and automatically extracting the one or more data elements using the trained machine learning model. The aspects further include generating an insight from the plurality of documents based on the extracted data elements.

An apparatus and system for data extraction are described. One or more aspects of the apparatus and system include a memory component, and one or more processing devices coupled to the memory component, the processing devices configured to perform operations of obtaining a document and a query; identifying, from the document, a plurality of data elements based on the query using a plurality of flexible anchor elements, respectively; extracting the plurality of data elements corresponding to the query based on the plurality of flexible anchor elements; and generating content including an analysis of the extracted data elements based on the query.

### BRIEF DESCRIPTION OF THE DRAWINGS

FIG. 1 is an illustrative depiction of a high-level diagram of users interacting with a remote data extraction system through their devices, according to aspects of the present disclosure.

FIG. 2 shows a block diagram of an example of a data analysis system according to aspects of the present disclosure.

FIG. 3 shows a flow diagram for a method of performing data extraction and a data analysis process for information elements, according to aspects of the present disclosure.

FIG. 4 is an illustrative depiction of a diagram of a data extraction system to perform data identification and data analysis, according to aspects of the present disclosure.

FIG. 5 shows an illustrative depiction of a document analysis for anchor identification and information element association for extraction, according to aspects of the present disclosure.

FIG. 6 shows an illustrative depiction of a document analysis and insight generation, according to aspects of the present disclosure.

FIG. 7 shows an illustrative depiction of a document analysis for anchor identification and information element association, according to aspects of the present disclosure.

FIG. 8 shows an illustrative depiction of a method of anchor identification and data extraction, according to aspects of the present disclosure.

FIG. 9 shows an illustrative depiction of a method of training an extraction component model, according to aspects of the present disclosure.

FIG. 10 shows an example of a computer system, according to aspects of the present disclosure.

### DETAILED DESCRIPTION

The present disclosure relates to data extraction and document analysis. Some embodiments include systems and methods for performing analysis and obtaining insights from semi-structured or unstructured documents, such as Portable Document Format (PDF) and HyperText Markup Language (HTML) documents, using the same application as that used to extract the information from the documents.

For example, two steps may be used to run an analysis on a table of information: (i) extracting data/information from the document, and (ii) performing analysis on the data/information extracted from the document(s) to make inferences and draw insights. The analysis functionality can be provided in-situ, rather than porting data and information to a separate application.

The data contained in documents may not be arranged or referenced in the same way in different documents, and each document can contain different information and content. Information may be contained in a document's text and tables. Different keywords may be used in different documents to identify the data/information and have the data/information extracted. Then an interactive tool that helps users perform analytics on the extracted data can be implemented by forming a tabular dataset or multiple linked tabular datasets and applying analysis tools to the tabular dataset(s), without transforming the data or moving it to another application. Some documents have multiple table entities.

Documents can contain data and information that can be used to obtain actionable insights. Mathematical calculations to obtain such insights and useful knowledge can be performed directly on the data contained within the documents without transferring or transforming the data for another software application. Some embodiments relate to performing analytics on data extracted from inherently unstructured documents by using machine learning to identify and extract the desired fields of interest.

Embodiments of the present invention provide an improved data analysis system that can analyze extracted information more efficiently and conveniently by embedding the tools with the extraction application. Some embodiments provide a user interface that enables an interactive, visual experience for users to extract and analyze relevant information (e.g., tables, text) from a single unstructured or semi-structured document, and across multiple documents that may be unstructured or semi-structured, automatically. A variety of analysis tools can be provided to a user without having to transfer or transform data to another application. The data extraction system can enable users to perform in-situ analytical operations (e.g., back-of-the-envelope calculations) on the extracted data through automated data insights, as well as a natural language interface all within the same interface and with just a few clicks and keystrokes. Embodiments of the disclosure can be implemented within a document reader or document editor to provide an improved document interaction interface.

### Network Architecture

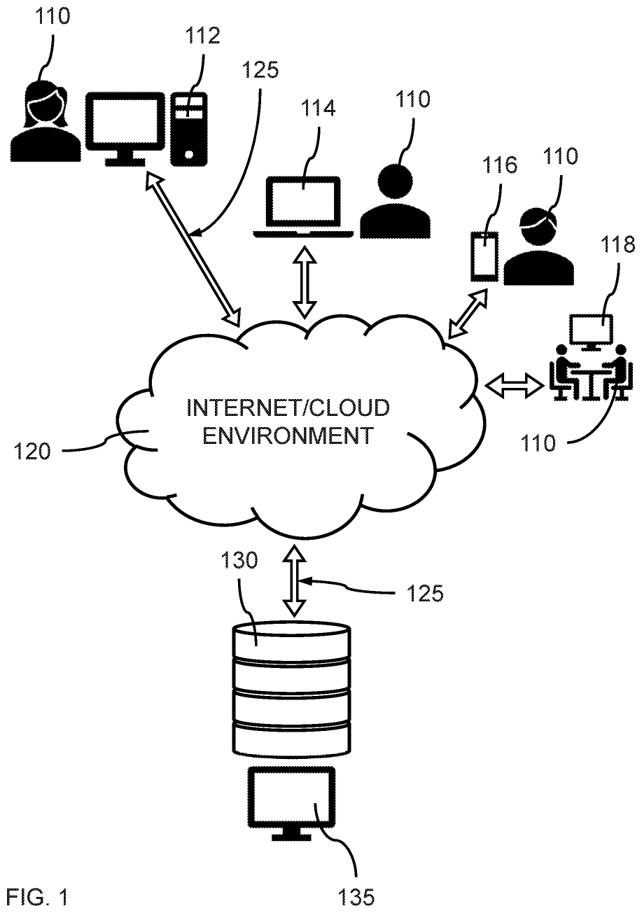

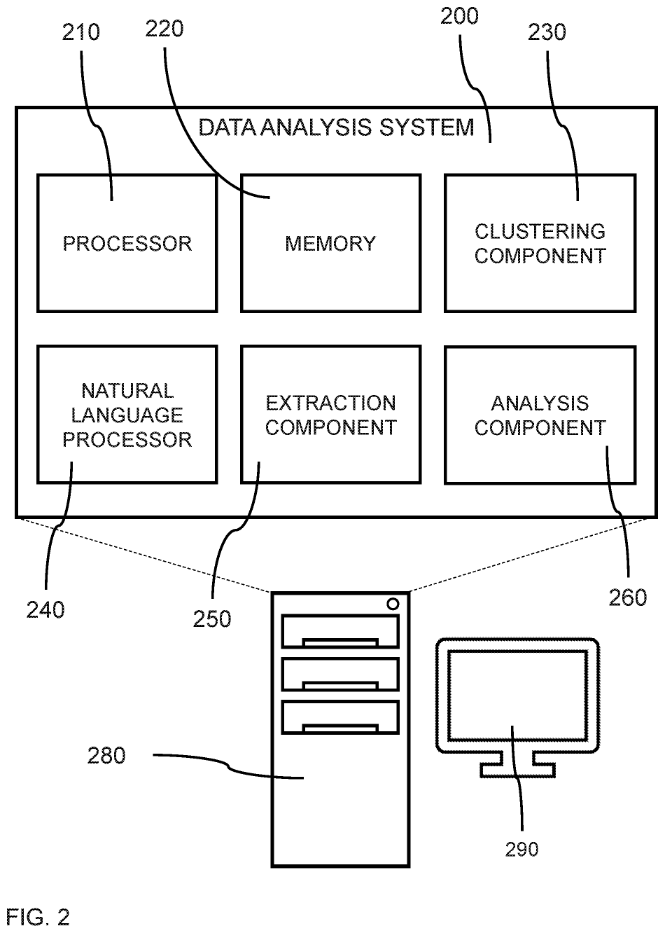

In FIGS. 1-2, an apparatus and method for data analysis are described. One or more aspects of the apparatus and method include a memory component; and one or more processing devices coupled to the memory component, the processing devices can be configured to perform operations comprising:

FIG. 1 is an illustrative depiction of a high-level diagram of users interacting with a remote data analysis system through their devices, according to aspects of the present disclosure.

In one or more embodiments, a user 110 can interact with a remote data analysis system 130 through the cloud/internet 120 by electronic communication 125. A user 110 may interact with the data extraction system 130 using, for example, a desktop computer 112, a laptop computer 114, a handheld mobile device 116, for example, a smart phone or tablet, or a smart tv 118. In various embodiments, the data extraction system 130 can include, for example, a deep neural network, including, but not limited to convolutional neural networks (CNN), transformer networks, encoder neural networks, natural language processors (NLP), and combinations thereof, although other deep neural networks are also contemplated.

In various embodiments, the user 110 can communicate 125 with the data extraction system 130 to submit documents for analysis and data processing, and receive results from the data extraction system 130, for example, identification of entities, dates, and calculations on data contained within the documents. The user 110 can provide documents for analysis and submit natural language queries to the data extraction system 130 requesting particular insights.

In various embodiments, the cloud 120 is a computer network configured to provide on-demand availability of computer system resources, such as data storage and computing power. In some examples, the cloud 120 provides resources without active management by user 110. The internet/cloud environment 120 can include data centers available to multiple users over the Internet, where the internet can be a global computer network providing a variety of information and communication facilities. Some large cloud networks have functions distributed over multiple locations from central servers. A server is designated an edge server if the server has a direct or close connection to a user 110. In some cases, cloud environment 120 may be limited to a single organization. In other examples, the cloud 120 is available to many organizations, where communication may be through the internet. In an example, the cloud/internet 120 includes a multi-layer communications network comprising multiple edge routers and core routers. In another example, cloud 120 is based on a local collection of switches in a single physical location. According to some aspects, the internet/cloud environment 120 provides electronic communications between user device(s) 112, 114, 116, 118 and the data extraction system 130.

In various embodiments, the user devices 112, 114, 116, 118 can include software that can communicate and interact with the data extraction system(s) 130, including, but not limited to, submitting a document or a digital image of a document for processing. Output from the data extraction system(s) 130 can be communicated to the user devices 112, 114, 116, 118, and/or displayed on a system display screen 135.

FIG. 2 shows a block diagram of an example of a data analysis system according to aspects of the present disclosure.

In various embodiments, the data analysis system 200 can include a computer system 280 including one or more processors 210, computer memory 220, a clustering component 230, a natural language processor 240, an extraction component 250, and an analysis component 260. The computer system 280 of the data analysis system 200 can be operatively coupled to a display device 290 (e.g., computer screen) for presenting prompts and images to a user 110, and operatively coupled to input devices to receive input from the user, including the original image(s).

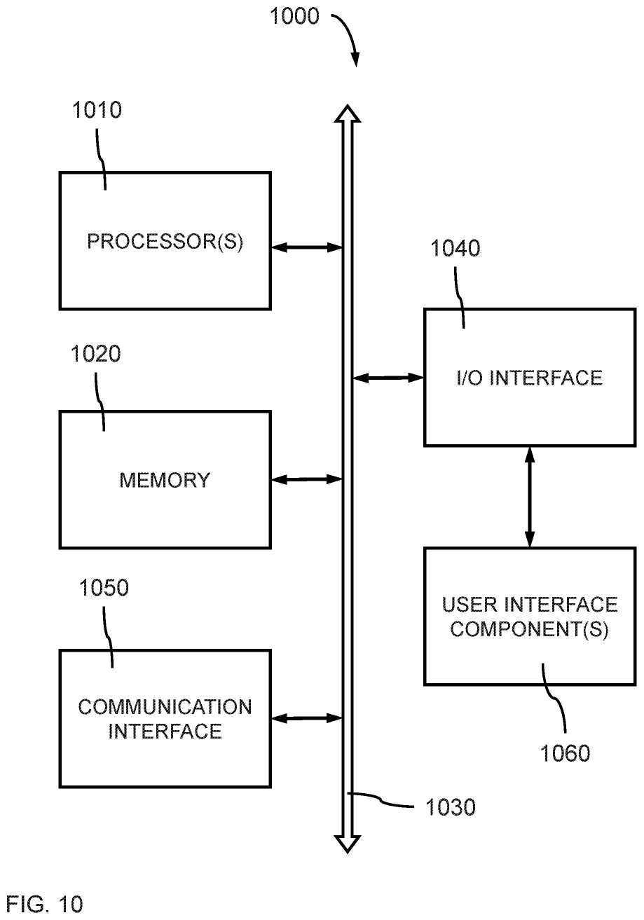

According to some aspects, processor unit 210 includes one or more processors. Processor unit 210 can be an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 210 is configured to operate a memory array using a memory controller. In other cases, a memory controller is integrated into the processor. In some cases, processor unit 210 is configured to execute computer-readable instructions stored in a memory to perform various functions. In some embodiments, processor unit 210 includes special-purpose components for modem processing, baseband processing, digital signal processing, or transmission processing. Processor unit 210 is an example of, or includes aspects of, the processor described with reference to FIG. 10.

According to some aspects, memory unit 220 comprise a memory coupled to and in communication with the one or more processors 210, where the memory includes instructions executable by the one or more processors 210 to perform operations. Examples of memory unit 220 include random access memory (RAM), read-only memory (ROM), or a hard disk. Examples of memory unit 220 include solid-state memory and a hard disk drive. In some examples, memory unit 220 is used to store computer-readable, computer-executable software including instructions that, when executed, cause a processor to perform various functions described herein. In some cases, memory unit 220 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory unit 220 store information in the form of a logical state. Memory unit 220 is an example of, or includes aspects of, the memory subsystem described with reference to FIG. 10.

According to some aspects, clustering component 230 can perform analysis on a plurality of documents using a computational model (e.g., a support vector machine (SVM)) that determines similarities between the documents, and groups them according to the detected similarities. Clustering may also utilize nearest neighbor analysis.

In various embodiments, the natural language processor (NLP) 240 can provide natural language analysis of the documents and provide natural language querying functions to the user. The natural language processor 240 can recognize words in the documents and calculate semantic similarity between words (or tokens) in the documents for an anchor metric. A query can be received from a user requesting particular data from the documents. The data analysis system 200 can analyze the query using a natural language processing (NLP) model to identify the type of data to be extracted from the documents and generate a response to the query based on the data. In various embodiments, a toolkit can support multiple linked tabular datasets as input. Language based analysis can be accomplished by the natural language processor 240 using the NLP model, for example, Bidirectional Encoder Representations from Transformers (BERT) or Generative pre-trained transformers (GPT), where a transformer is a deep learning architecture that relies on an attention mechanism.

In various embodiments, users can ask questions using natural language, for example, “Show me the total expense grouped by employee name as a bar chart,” “Correlate expenses across categories,” “Visualize the expense trend this month as a line chart,” etc. The natural language processor 240 can be trained to parse the query and produce the requested output for the user.

In various embodiments, the extraction component 250 can identify and extract the data associated with an information element, for example, where a table of items can be an information element in a purchase order, the actual list of items and prices would be the data associated with the information element (i.e., the table). The extracted data can be provided to a user and used for analytics and calculations.

In various embodiments, the analysis component 260 can be configured to perform various calculations on the extracted data to provide insights to the user. The insights can be values not directly observable in the data values, for example, totals, averages, and relationships between different data/information elements. The analysis component 260 can include a generative machine learning model. For example, the analysis component can be a machine learning model trained on user queries and the types of insights to calculate and present to the user. For example, the training data may include data related to total sales, total costs, sales people with the highest quarterly sale, etc., and may involve data extraction and analysis across multiple documents.

### Data Extraction

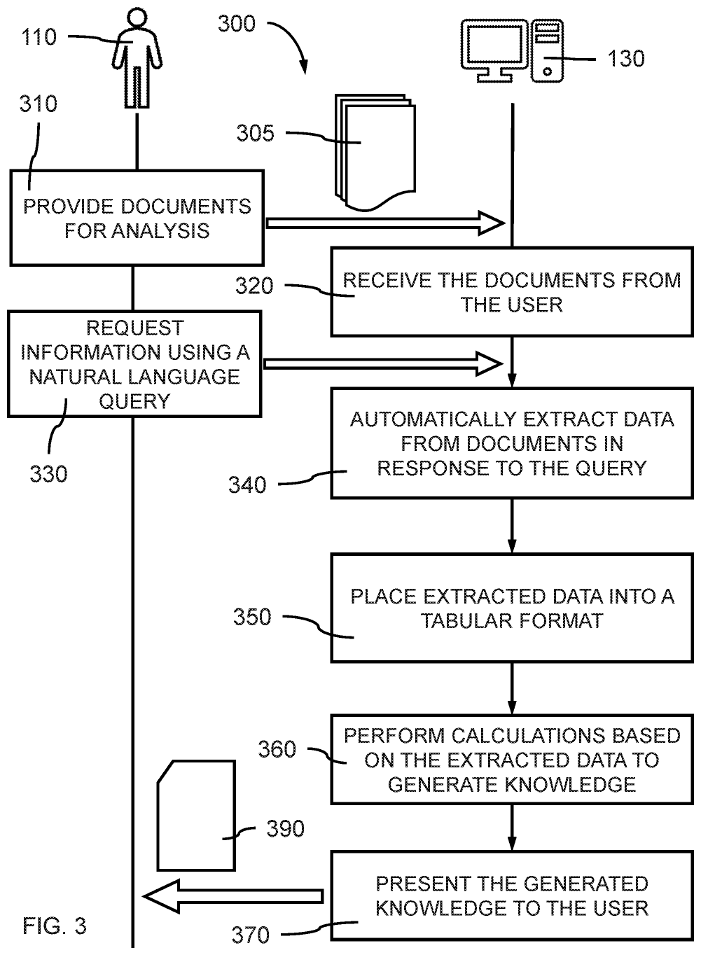

In FIGS. 3-8, a method, apparatus, and non-transitory computer readable medium for image processing, data extraction, and data analysis are described. One or more aspects of the method, apparatus, and non-transitory computer readable medium include identifying a document and an information element; identifying, from the document, an anchor element that has an anchor type and a relationship type, wherein the anchor type describes a structure of a set of anchor elements, and the relationship type describes a relationship between the anchor element and the data/information element; extracting data/information corresponding to the information element based on the anchor element, the anchor type, and the relationship type; and providing insights to the user based on the extracted data/information.

Some examples of the method, apparatus, and non-transitory computer readable medium further include identifying a plurality of anchor candidates for locating the information element, wherein the anchor element is selected from the plurality of anchor candidates.

Some examples of the method, apparatus, and non-transitory computer readable medium further include displaying the plurality of anchor candidates to the user; and receiving an anchor selection input from the user, wherein the anchor element is selected based on the anchor selection input.

In some embodiments, the anchor type comprises a single anchor type, a multiple anchor type, a hierarchical anchor type, a self-anchor type, or a combination anchor type. In some embodiments, the relationship type comprises a position type, a structure type, a style type, or a semantic similarity type.

Some examples of the method, apparatus, and non-transitory computer readable medium further include locating the information element in the document based on the anchor element, the anchor type, and the relationship type, wherein the information is extracted from the information element.

Some examples of the method, apparatus, and non-transitory computer readable medium further include determining that the relationship type comprises a position type; and identifying a position relationship between the information element and the anchor element, wherein the information element is located based on the position relationship.

Some examples of the method, apparatus, and non-transitory computer readable medium further include determining that the relationship type comprises a structure type; and identifying a structural relationship between the information element and the anchor element, wherein the information element is located based on the structural relationship.

Some examples of the method, apparatus, and non-transitory computer readable medium further include determining that the relationship type comprises a style type; and identifying a style relationship between the information element and the anchor element, wherein the information element is located based on the style relationship.

Some examples of the method, apparatus, and non-transitory computer readable medium further include determining that the relationship type comprises a semantic type; and identifying a semantic relationship between the information element and the anchor element, wherein the information element is located based on the semantic relationship.

Some examples of the method, apparatus, and non-transitory computer readable medium further include determining that the anchor type comprises a multiple anchor type; and identifying an additional anchor element, wherein the set of anchor elements includes the anchor element and the additional anchor element, and the information is extracted based on the anchor element and the additional anchor element.

Some examples of the method, apparatus, and non-transitory computer readable medium further include determining that the anchor type comprises a hierarchical anchor type; and identifying an additional anchor element having a hierarchical relationship to the anchor element, wherein the set of anchor elements includes the anchor element and the additional anchor element, and the information is extracted based on the anchor element and the additional anchor element.

Some examples of the method, apparatus, and non-transitory computer readable medium further include determining that the anchor type comprises a self-anchor type, wherein the information is extracted from the anchor element.

FIG. 3 shows a flow diagram for a method of performing data extraction and a data analysis process for information elements, according to aspects of the present disclosure.

In various embodiments, a data analysis process 300 is provided, where data/information elements can be identified, and data associated with the information elements can be extracted from a plurality of documents 305 for calculations and analysis.

In various embodiments, at operation 310 a user 110 can provide a plurality of documents 305 to the data analysis system 130 for data extraction and analysis. The documents 305 submitted to the data extraction system 130 can be unstructured or semi-structured documents, (e.g., PDF's, HTML, XML, etc.). The documents can include text, tables, graphics, etc. The information and data can be contained within the documents as ASCII characters. In various embodiments, the documents are not spread sheet documents. The data may not be contained within pre-segregated cells of a spread sheet holding numerical values.

At operation 320, the data extraction system(s) 130 can receive the plurality of documents 305, and analyze the documents for similarities. The documents 305 can be clustered based on the detected similarities, where a similarity can be the format of a subset of documents, for example, a plurality of invoices having the same arrangement of buyer fields and item entries in comparison to healthcare documents listing patients and treatments/services.

In various embodiments, the data extraction system 130 can automatically identify one or more anchor candidates, where the anchor candidates can be identified for documents 305 in a cluster based on a plurality of metrics. The anchor candidates can be associated with the data/information to be extracted.

At operation 330, the user can provide a natural language query to the data extraction system 130, where the natural language query can request particular information and insights be generated from the data included in the plurality of documents 305. A natural language interface can be provided to the user 110 for asking additional questions about the data using the querying power and expressivity of natural language. A natural language model can translate the natural language query into an algorithm for the data extraction system 130 to identify and extract the pertinent data. For example, the natural language query can request monthly tallies of invoice amounts based on dates from a collection of invoice documents having a table of invoice amounts and a date field. The natural language model can generate a set of instructions and keywords for identifying the requested data in the documents, and the type of operations involved in obtaining the requested insights. This may be done across documents in an efficient manner without leaving the initial document application tool (e.g., PDF reader, HTML/XML browser, etc.).

At operation 340, the data extraction system 130 can extract the data/information based on the fields associated with the data identified in the documents 305. The data matching the requested information can be identified based on the fields in the documents and the data values in the fields can be extracted. The data extraction system 130 can automatically associate one or more anchor candidates with one or more target information elements for data extraction from the plurality of documents 305. The user 110 may also identify one or more information elements in at least one document, where the user 110 can select the information element from the text and data fields in the document using a graphical user interface (GUI). After selecting (extracting) data from a single document, the user 110 can switch to an Overview page to see the extracted data across all other documents, where the documents may be within a cluster.

In various embodiments, for example, the data extraction system 130 can automatically extract the desired entities of interest (“Client Name”, “Invoice Date”, “Client Tax ID” as well as the Purchases table—“Description”, “Qty”, and “Gross worth”) across all documents 305.

At operation 350, the data extraction system 130 can place the extracted data into a tabular format that can be used for calculations on the data values. The tabular format can be multiple tabular datasets curated from the data extracted within a single document as well as across multiple documents. The data can be combined and structured after being extracted from the data source (e.g., document). Text characters for numbers can be translated into their numerical values for storage in the tabular format.

The analysis tools of the analysis component 260 in the data extraction system 130 can support multiple linked tabular datasets, like normalized schemas in relational databases. In a normalized table, each column that is not part of the primary key can be dependent on the key. The goal of normalized schemas is to avoid storage of duplicate data, so that stored data cannot become inconsistent. A flat table (denormalized schema) may be created, but the normalization aspects pertaining to the repeating data entities may be tracked to avoid processing the duplicate data entries multiple times during computations. Normalization is the process of determining how much redundancy exists in a table, and to characterize the level of redundancy in a relational schema.

In various embodiments, a natural-language toolkit can extract attributes from the user's query and check to see if the attributes all belong to the same table, for example, “ClientId” and “SellerId”) or are referenced across tables (e.g., “ClientId” and “Array[Transaction Amounts]”. For attributes that are referenced across tables, the toolkit can process the attributes accordingly to produce a visualization because the system knows that Table 1 and Table 2 share a 1:n relationship (i.e., for each row in Table 1, there may be multiple rows in Table 2). For example, if the query is “Show me a visualization of the Client's ‘Experience_In_Years’ and “Total Revenue”, the system knows that ‘Experience_In_Years’ is in Table 1 (where each row corresponds to a client) and ‘Total Revenue” can be computed from Table 2, where each row is a transaction with revenue, by applying a SUM( ) function to the table. The system can apply a SUM( ) on the “Revenue” column to generate Total_Revenue, but would not apply SUM( ) to ‘Experience_In_Years’ because such a sum would be meaningless.

As a result of these transformations, a single, denormalized table, that has two columns: ‘Experience_In_Years’ and ‘SUM(Revenue)’ (which is actually ‘Total_Revenue’) can be obtained. Extending this to three tables, if Table1: Table2=1:n and Table 2:Table3=1:m, and if a user query includes all three tables, it can be treated as a 1:min combination query and be processed in that manner to produce a single, derived table generated from multiple normalized tables.

At operation 360, the data extraction system 130 can perform calculations on the extracted data, where the calculations can be performed by the analysis tools. For example, the data extraction system 130 can extract the data based on the fields and calculate the invoice total for each month from the date information and invoice amounts, or, for example, “Show me the total expense grouped by employee name as a bar chart,” “Correlate expenses across categories,” “Visualize the expense trend this month as a line chart,” etc.

In various embodiments, users can perform formula-based calculations, such as average( ), min( ), max( ), etc., and also perform cell manipulations such as adding/removing rows and columns using analysis tools of the analysis component 260.

At operation 370, the extracted data and insights 390 can be presented to the user. The extracted data and data insights 390 can be formatted in a manner determined by the user 110, for example, as a document on the user's device and/or a display of the data extraction system 130, as a printed hard copy output, as a data file, etc. The extracted data and data insights 390 can be in the form of text, tables, figures, charts, etc.

In various embodiments, during analysis, either through the natural language interface, spreadsheet-calculations, or browsing automated data facts, the user 110 may want to save certain insights, e.g., a supporting visualization or a table row/column/cell reference or a direct data fact. The data extraction system 130 can provide users 110 a function to bookmark the generated insights for subsequent inclusion as part of a summary report. These insights can be made available in a new “Dashboard” tab of a graphical user interface (GUI).

In some cases, the original document is an unstructured document (i.e., it is stored in a manner that does not conform to a schema specific to the data elements extracted from it). After data elements are extracted, they can be associated with fields of a data schema and inserted into a structured database such as a tabular dataset or multiple linked tabular datasets.

In some cases, an additional document is generated based on the generated knowledge or content. For example, a document describing the original document can be generated or an alternative to the original document can be generated by modifying elements of the document based on the insights.

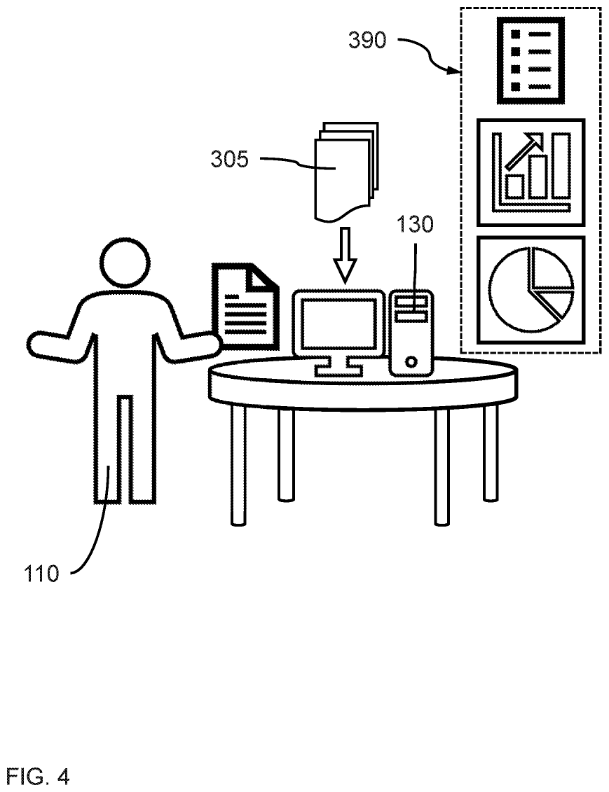

FIG. 4 is an illustrative depiction of a diagram of a data extraction system to perform data identification and data analysis, according to aspects of the present disclosure.

In various embodiments, a user 110 can provide a plurality of heterogeneous, unstructured and/or semi-structured documents 305 to the data analysis system 130 to obtain insights 390 from data/information extracted from the plurality of documents 305. The data analysis system 130 can include tools for providing the extracted data and data insights 390 to the user 110.

Various kind of documents (e.g., invoices, purchase orders, stock lists, medical charts, emails, etc.) can each have their own formats, such that a collection of documents is heterogeneous, even documents utilized for the same purpose, can be heterogeneous. Each user or client can impose his/her own formatting and style to each class of document, for example, purchase orders, shipping orders, invoices, notifications, emails, etc. The lack of a formal, consistent structure in these semi-structured and unstructured documents (e.g., PDF, HTML, XML, etc.) can make identifying and extracting data difficult. In addition, these formats can change over time, such that substantive changes may be made between generations of documents and formats.

Specific anchors may not occur in all documents or in the neighborhood of particular predetermined fields of the documents. For example, a document of a hotel reservation confirmation may specify a “Check-In Date:” and Check-Out Date:”, or “Check-In” and “Check Out”, or “Arrival” and “Departure”, or “Reservation: Tuesday, May 5^{th} to Friday, May 8^{th}”, or lack a Heading or Title. There can be different formats and wording. The placement of such anchors on the document may also vary, where the examples for the hotel reservation may appear at the top or bottom of the document with varying information in between, and may be above or laterally adjacent to the information element specifying an information element.

To address variation between documents, flexible anchor elements can be implemented, where the flexible anchor elements can identify common, repeating entities across multiple documents to help locate information elements (e.g., data values) for extraction. Each information element (e.g., data value) can be associated with a plurality of flexible anchor elements based on the anchor's and information element's relationship in terms of one of certain metrics (e.g., “position”, “style”, “structure”, and “semantics”).

In various embodiments, the system can provide for human-assisted bulk extraction of desired data/information from multiple documents, where the user can optionally override the system's automatic determination of anchor elements and relationships. In cases where the tool fails to automatically determine appropriate anchor elements, users can override them by interactively annotating within the document. The tool may also infer the user's “anchoring” strategy and use such anchoring strategy for the data extraction. An extraction program can be based on the relationship between a desired information element and its corresponding anchor(s), and provide interactive data extraction from a batch of documents.

In various embodiments, a user can select desired information elements from a document, and the system can automatically identify and associate relevant anchor candidates to the target information elements. The system can automatically associate the most appropriate anchor with each of the user selected information elements. For example, for a desired information element, invoice dates, e.g., “01/01/2021”, a suitable anchor could be the label, “Invoice Date:”.

In various embodiments, the system can determine between the HTML-like structural identity of the information element and each anchor candidate. In various embodiments, the system can determine semantic similarity between the information element and each anchor candidate, where a higher similarity score can signify semantically more relevant anchors.

In one or more embodiments, techniques can be used to extract tables, images, algorithms and formulae, as well as layouts and styles from documents. The document can be a text document or an image document (e.g., scanned document). The techniques can be Machine Learning (ML) based techniques that can utilize neural networks, probabilistic models, and Markov logic networks. In-situ analytics can be applied to the extracted data to automatically computes insights, for example, calculate running totals, identify maximum values, and perform arithmetic operations based on additional natural language questions asked about the data.

In one or more embodiments, after selecting and extracting data from a single document, the user can switch to an overview page to see the extracted data across all other documents within a set of documents (also referred to as a cluster). When the user selects another desired entity, for example, of “Text” type: “Client:” they start seeing some insights in an Insights panel.

In various embodiments, during analysis, either through the natural language interface, spreadsheet-calculations, or browsing automated data facts, the user may want to save certain insights, e.g., a supporting visualization or a table row/column/cell reference or a direct data fact. This may be included as part of a summary report.

In various embodiments, a spreadsheet-interface, where a user can perform formula-based calculations such as average( ), min( ), max( ), etc., and also perform cell manipulations such as adding/removing rows and columns is provided.

In one or more embodiments, an ML model trained in real time can extract user-specified data/information elements from across multiple documents. In various embodiments, the ML model can be a deep neural network, a convolutional neural network (CNN), or a transformer-based model. In various embodiments, a hard-coded software model may be used to identify data elements.

To extract entities from across multiple documents, the system can trace the same information element relationship that was learned from an initial document, but in reverse. For example, consider where a user interacts with one of many documents and selects “John Doe” as an information element, “Client Name:” as the corresponding (single) anchor, and the relationship based on “structure” and “proximity” (e.g., the anchor is an HTML <H1> tag and the information element is the closest HTML <P> tag). Next, to locate and extract the same information element from other documents, the model will first locate the anchor by string match (i.e., “Client Name:”) and also structure match (i.e., <H1>); then, the model can scan for nearby elements with the <P> tag and select the one that is closest (by computing inter-element distance). This selected element is the information element across other document(s).

BERT is an example of a language model that can be used to encode words from a document, BERT trained on a large document corpus to determine semantic similarity (from 0 to 1) between two n-grams: the desired information element and the anchor candidates. In various embodiments, the value of n for the n-grams can be in a range of 1 to 3, to capture single word entities (e.g., “Buyer”, “Seller”, “Item”, etc.), bi-word entities (e.g., “Purchase Date”, “Invoice Date”, etc.), tri-word entities (e.g., “Check In Date:”, “Date of Issue”, etc.).

After the user specifies the desired information elements, the system can automatically extract the data and provide the extracted data to the user in a predetermined format, for example, a table. In various embodiments, support for multiple tabular datasets (instead of one single tabular dataset) curated from the data extracted within a single document as well as across multiple documents is provided. In various embodiments, the system enables interactive data extraction from a batch of documents.

While analyzing a document of interest for fields that are consistent across multiple, similar documents can reveal textual “landmarks, a single, nearest landmark is not always effective for locating information to be extracted. Documents frequently evolve over time in terms of layout, styling, and content. Extracting information can also be difficult due to the inherently unstructured nature of the documents.

According to embodiments of the present inventive concept, flexible anchor elements can locate and identify target information elements across different types of documents and satisfy different types of user needs. Flexible anchor elements can be used to identify multiple relationships corresponding to common information elements across different documents, respectively. At least a portion of a plurality of the anchor elements may stay consistent across multiple documents, and can reliably help find the associated information elements. The system may identify the associated data/information elements based on a portion of the plurality of the anchor elements. For example, “Invoice Date” is likely to be in purchase order, packing slip, and shipping order type documents, whereas the actual associated date would be different between different documents, unless all of the documents were generated on the same date. When existing sections of a document are reordered (e.g., credit and debit columns in a table are swapped), because new sections have been added (e.g., new fields), or there are stylistic makeovers to certain content (e.g., some font sizes are increased, bolded or italicized), the anchors themselves would remain consistent.

In various embodiments, an information element can have a plurality of associated anchor elements, where different anchors can operate in the same document, for example, the information relating to a buyer may be directly below a label, “Buyer” but also directly above a label, “Items”. Both of the labels can function as anchors within the same document to identify the information element, the actual buyer; whereas, different labels “Buyer” or “Purchaser” may function as anchors across different documents using the different terms to identify the same information. It is unlikely that the same document would include both a “Buyer” label and a “Purchaser”, since the two labels would be synonymous and used in the same capacity.

In various embodiments, the anchor element types are determined based on their relationship with the data/information element of interest in terms of their relative similarity.

Various keywords, for example, “Date”, “Description”, “Quantity”, “Price”, Total, etc., that can provide a description of the associated data/information, can appear in similar documents and act as anchor elements. The actual words/anchors, however, may not show up in the same location in different documents, and even the words may vary, for example, “quantity” may be used but “amount” may be used in other documents, or at different locations in the same document.

In various embodiments, a BERT language model trained on a large document corpus, for example, can be used to determine semantic similarity (from 0 to 1) between two n-grams: the desired information element and each anchor candidate. This may not only help with extraction but also semantic data modelling, where meaningful schemas can be automatically generated across documents. The system can look for repeating n-grams across all documents that can then help reliably locate (and hence, extract) other dynamically updating entities around them.

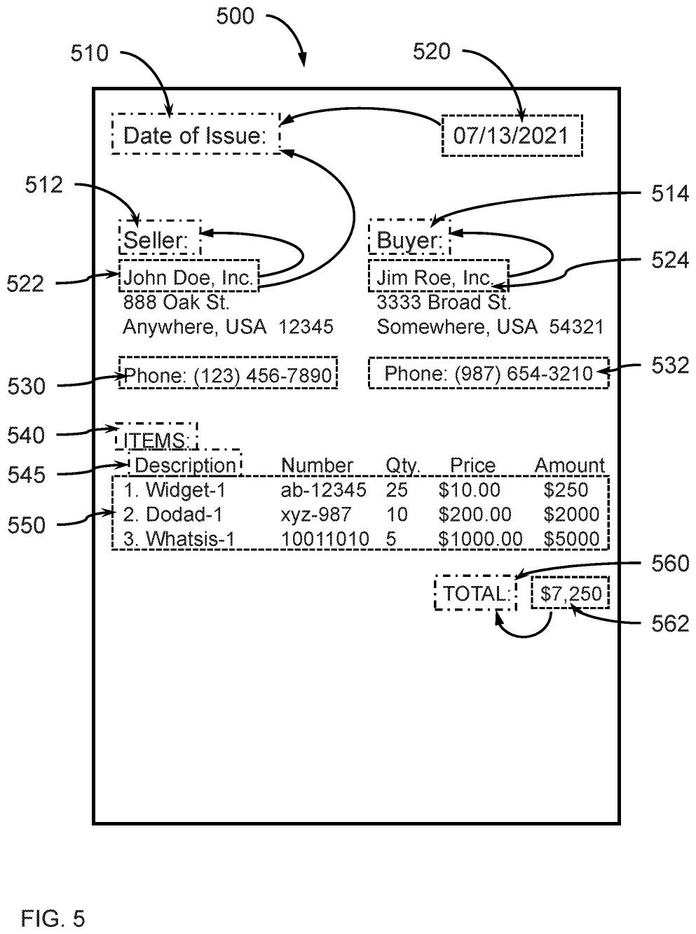

FIG. 5 shows an illustrative depiction of a document analysis for anchor identification and information element association for extraction, according to aspects of the present disclosure.

In various embodiments, a document 500 can include one or more flexible anchor elements 510, 512, 514, 540, where the flexible anchor elements can be titles and/or headings in the document, that identify associated data and information. The associated data and information can be identified as information elements 520, 522, 524, 550, where the information element can be a label attached to a data field representing the data of interest. That is, an information element can be a generic identifier for an actual data value without being limited to the actual value. For example, the date field associated with the anchor element, “Date of Issue” can be an identified information element, that contains a data value of, “07/13/2021”. Information elements would relate to the data field having a date formatted piece of data, and not the specific value of “07/13/2021” in the document, since the specific value may vary across documents. Searching a plurality of documents for an information element of interest would identify each of the dates in the document field having “date” formatting, and not just the specific value in the document used to identify the information element, “07/13/2021”.

In various embodiments, the information element 520 (“07/13/2021”) can be associated with the anchor element 510 (“Date of Issue”) based on a plurality of metrics calculated for the relationship between the information element 520 and the anchor element 510. The relationship can take into account the relative positioning of the information element 520 to the anchor element 510, where the information element 520 is located on the same horizontal line as the anchor element 510, and within a measurable distance (number of pixels). Other anchor elements may be physically closer to the information element 520 (“07/13/2021”), for example, flexible anchor element 514 (“Buyer”), but other metrics, for example, semantic similarity, can increase the probability of anchor 510 (“Date of Issue”) being the proper anchor selected for the information element 520 (“07/13/2021”).

In various embodiments, the flexible anchor element 510 (“Date of Issue”) can be identified as a “single” type anchor for the information element 520 (“07/13/2021”), where the anchor element 510 is the only anchor associated with information element 520. The information element 522 (“John Doe, Inc.”) can be associated with anchor elements (“Seller”) 512 and (“Date of Issue”) 510, where the anchors 510 (“Date of Issue”) and (“Seller”) 512 can be identified as a “multiple” type anchors for the information element 522 (“John Doe, Inc.”).

As a non-limiting example, Anchor 1 (“Seller”) and Anchor 2 (“Date of Issue”) can be multiple anchors for the “John Doe” information element 522. Anchor 1 is semantically similar; whereas Anchor 2, even though it is not semantically similar, might be more effective from a proximity standpoint. Together, this multiple anchor combination can more effectively locate and extract target information elements. In some documents, “Date of Issue” may work better, while in other documents “Seller” may be more effective; together, the anchors would have higher coverage and accuracy.

In various embodiments, the information element 530 (“Phone: (123) 456-7890”) can also be an anchor element identified as a “self” type anchor, due to the pairing of “Phone:” and “(123) 456-7890”, where it may appear as a single field. The user can split the information element 530 into an associated anchor element, “Phone”, and a value, “(123) 456-7890” for the information element 530, where the anchor element, “Phone”, can be consistent, while the value changes.

In various embodiments, the flexible anchor element 540 (“Items:”) can be associated with a table of data identified collectively as an information element 550. In various embodiments, the two flexible anchor elements “Phone:” may each be hierarchically associated with the anchor element 512 (“Seller”) or anchor element 514 (“Buyer”), respectively. Similarly, anchor 512 (“Seller”) and anchor 514 (“Buyer”) can be hierarchically associated with the anchor 510 (“Date of Issue”). In various embodiments, an information element 562 (“$7,250”) can be associated with the flexible anchor element 560 (“Total”), where anchor element 560 is a single type anchor.

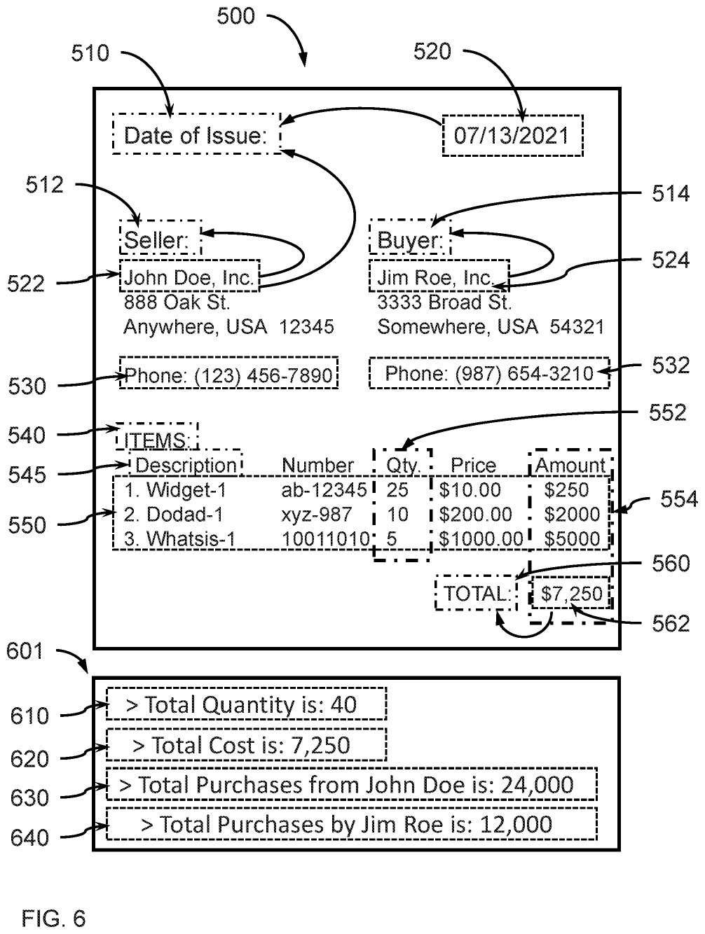

FIG. 6 shows an illustrative depiction of a document analysis and insight generation, according to aspects of the present disclosure.

In various embodiments, the document 500 can have anchors automatically identified and the data extracted based on the anchors, where the extracted data can then be used for analytics and insight generation. The anchors and data can be identified based on a user query requesting particular data and insights. The anchor(s) can be used to locate the data, and an extraction component can gather the associated data and add it to a data structure utilized for calculations and generating insights. The data structure, extracted data, and calculated values may be stored in a memory.

In various embodiments, the data extraction system 130 can extract the data into tables, and calculations can be performed on the data to generate insights 601 presented to the user. The user may specify the data of interest, for example, by circling a quantity column 552 and circling an amount column 554 in an items table 550. The extraction component can extract the data identified by the user.

In various embodiments, the insights 601 can include, for example, a total number of items purchased in one invoice document 610, the total cost of the items purchased 620, which may or may not be in the document, a total amount purchased from the same seller 522, John Doe, 630 over a time period, or a total amount purchased by a particular buyer 525, Jim Roe, 640 over a time period. The total purchase amounts over a fixed time period can involve anchor identification, data extraction, and data analysis across multiple documents fitting the time period criteria. The analysis may provide other insights, for example, a top seller for a time period, or the item with the greatest quantity purchased year-to-date, based on a trained model for the analysis component.

In various embodiments, the generated insights 601 can be presented to the user as a table, a graph, a chart, etc., where the user may indicate the format as part of a query for the data analysis.

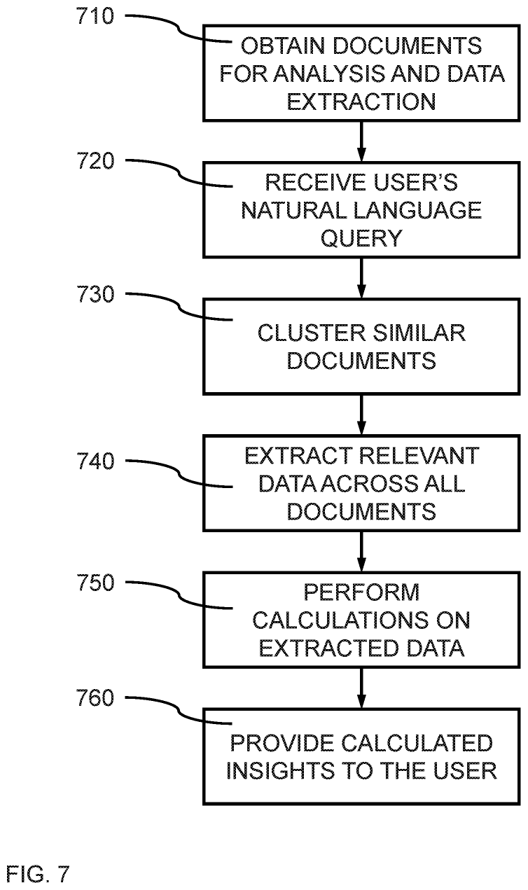

FIG. 7 shows an illustrative depiction of a document analysis method, according to aspects of the present disclosure.

At operation 710, the documents can be obtained for analysis, where the data analysis system can obtain the documents from a user. The documents may be PDF documents, HTML documents or web pages, XML documents or web pages, or other unstructured or semi-structured documents. The documents can include text, tables, graphics, etc. The document may not be a spread sheet.

At operation 720, the data analysis system can receive a user's query, where the query can be a natural language query. The user's query can be semantically parsed and interpreted by an NLP model, for example, GPT, and data can be identified based on the query. A natural language model can translate the natural language query into an algorithm for the data extraction system 130 to identify and extract the pertinent data, and generate the user-requested output. The NLP model can utilize the language grammar for interpreting the query, based on the language of the training set used to train the model, and the sequence of words in a query.

At operation 730, the documents can be analyzed, and similar documents, for example, documents having the same spatial format can be clustered, so the same anchors may be used to extract the relevant data.

At operation 740, relevant data can be extracted from multiple documents, where the data may be extracted across all the input documents. The clustering may be used to increase extraction accuracy and efficiency. The extracted data can be input into data tables, where the tables may be multiple linked tabular datasets. The extraction component can create a flat table (denormalized schema). Text (e.g., ASCII characters) representing numbers may be converted into their respective numerical value (e.g., integers, real/floating point, etc.) for calculations.

At operation 750, calculations can be performed on the extracted data to generate insights, where the calculations can include arithmetic operations, min/max/operations, data manipulations, and filtering. The calculations can be formula-based calculations, where the user can provide a mathematical formula and indicate the data to be used in the formula variables. The user may provide formulas through a GUI.

At operation 760, the calculated insights can be presented to the user, where the insights can be calculated and presented automatically from the extracted data based on the training of the network model of the analysis component.

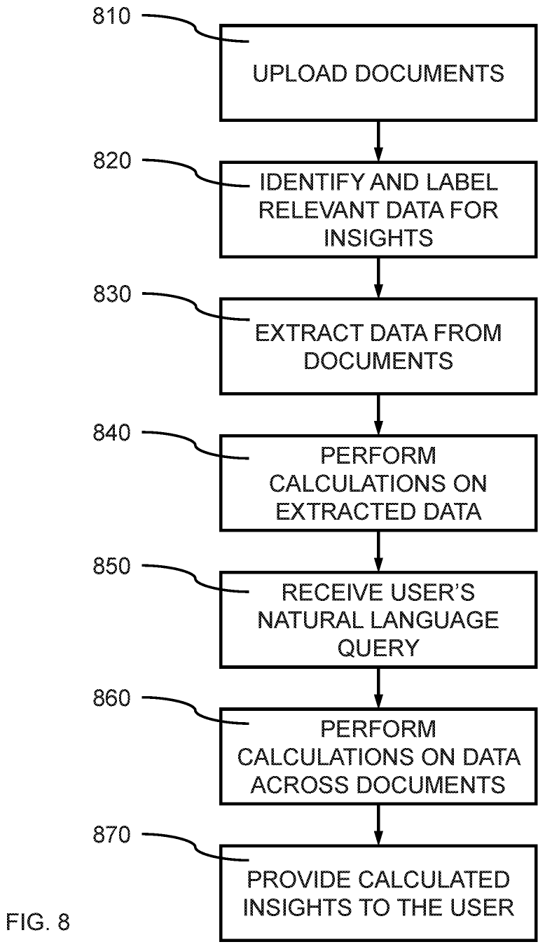

FIG. 8 shows an illustrative depiction of a method of anchor identification and data extraction, according to aspects of the present disclosure.

At operation 810, a plurality of documents can be uploaded to the data analysis system, where the plurality of documents can be identified or submitted by a user to the data analysis system over a communication channel. The documents can be unstructured or semi-structured documents, for example, PDF documents. The plurality of documents can contain similar data that can be identified by anchor elements present in each of the plurality of documents, where the anchor elements do not have to be consistent between documents. A data extraction component can include a machine learning model trained to identify information elements and anchor elements.

In various embodiments, the plurality of documents can be uploaded by a user from a user's device. The user can upload, for example, “N” heterogeneously formatted documents, for example, as a mixture of invoices, contracts, healthcare reports, etc., where “N” is the number of documents.

At operation 820, the data analysis system can analyze the plurality of documents to identify similarities, and can cluster the documents based on the similarities. The documents can be analyzed and clustered using a trained neural network (e.g., a support vector machine (SVM)). For example, the system clusters similarly structured documents together, where there are three resulting clusters, one for each of the invoices, contracts, and healthcare, and identifies “one best/representative” candidate document within each cluster to begin selective extraction.

In various embodiments, the extraction component can cluster documents having the same format(s) based on a similarity measure, for example, Density-Based Spatial Clustering of Applications with Noise (DBSCAN) to group similarly structured documents together. Clustering Similarly Structured Documents together from uploaded documents, for example, could generate an “invoices cluster” and a “healthcare-cluster” (like separating apples and oranges from a fruit basket), where Invoice-type documents would form a separate cluster from the patient healthcare documents.

The extraction component can identify the data in the documents based on anchors, where the anchors can be associated with particular data entries using a trained model. The data extraction system can automatically identify flexible anchor element candidates for potential information elements. The anchor candidates can be identified based on a plurality of relationships between document entries and each of the anchor candidates, where the anchor candidates can be hierarchically sorted based on calculated values for each of the different relationships. A set of anchor elements associated with each of the one or more identified information elements can be automatically identified using the trained machine learning model, wherein each of the anchor elements in the set are associated with an anchor type that describes a structure of the set of anchor elements.

In various embodiments, potential anchor candidates can be identified for each of the document clusters, where a particular identified anchor element may be consistent between documents in the same cluster. Potential anchor candidates can be determined for each of the detected document clusters. In particular, the system can look for repeating n-grams across all documents in a cluster that can then reliably locate and extract other dynamically updating entities around them. Entities that are stylistically (e.g., Font Weight >400-bolder text) and structurally (e.g., <H1,2,3,4> or <Title>-like tags) indicative of titles and headings can be scored higher than other entities such as <Span> and <P>.

In various embodiments, once the anchor candidates are determined, the system can automatically associate the most appropriate anchor from the candidate list with the selected information element, when the user selects the desired information elements from a document. For example, for a desired information element indicated as a date, “01/01/2021”, a suitable anchor could be the label, “Invoice Date:”. The user can select a desired information element, for example, “Items” table, and may selectively extract the “Description”, “Qty”, and the “Gross worth” columns only.

In various embodiments, a document can be preprocessed to identify and extract different information elements, for example, “text,” tables”, “figures”, where for example, preprocessing can automatically extract content and structural information from the documents (e.g., PDF documents) that may be native or scanned, and output the extracted content in a structured JavaScript Object Notation (JSON) format.

For the text labels in the documents: “Shipping Date:”, “Mail Date:” and “Invoice Date:”, the system can determine their string values to compare and distinguish between the text labels; whereas, if only the values (e.g., 20/12/2012) are used, then the learned anchor rule can help distinguish between them. For example, if “20/12/2012” is anchored to “Seller” and named “Invoice Date”, then during multi-document extraction, “Seller” can be traced to some other date (e.g., “29/12/2012”) by applying the learned extraction rule.

At operation 830, the identified data for different anchors can be extracted for subsequent analysis and calculations. The data can be extracted from the plurality of documents and incorporated into tables for calculation.

In various embodiments, the data extraction component can learn from the user-defined anchors and apply a revised strategy for information element identification and data extraction. The system can infer this by reverse-engineering the most important feature for determining anchors based on the user's annotation. For example, if the user chooses the nearby term, “Date:” as an anchor for the “01/01/2022” information element; and if the ranking of “Date:” is recognized as having the highest value for the “Distance Vector (magnitude)” and “Semantics” scores, then these features can be adjusted to be weighted higher than the other metrics, for example, Distance (angle), Structure, Style (Font Size) and Style (Font Weight) for re-computing the overall scores of the other anchor candidates. This re-learning strategy can be used for annotating semantically relevant entities within a document and preparing a dataset for other learning-based approaches.

At operation 840, automatic calculations can be performed on the extracted data using a trained model of the analysis component. The analysis component can be trained to automatically identify insights and perform calculation that may be of interest to the user. For example, a user may wish to know the monthly totals for accounts receivable and monthly expenditures, as well as yearly totals. The analysis component can identify the data in the tables and preform the calculations without the user providing a specific query for that information.

At operation 850, the data analysis system may receive a natural language query from a user, where the query identified particular data and calculations to be performed. The query can be parsed and interpreted to generate an algorithm to utilize a subset of the extracted data for a calculation, where the data and calculations can be across a plurality of different documents.

At operation 860, the analysis component can perform calculations on the subset of extracted data to generate one or more insights. The calculations can be performed across multiple documents, for example, all invoices issued in the same month or year, or all purchase orders issued by the same employee.

At operation 870, the insights can be provided to the user. The generated insights can be provided in a predetermined format, for example, a file format, a printed format, or an on-screen format.

### Training and Evaluation

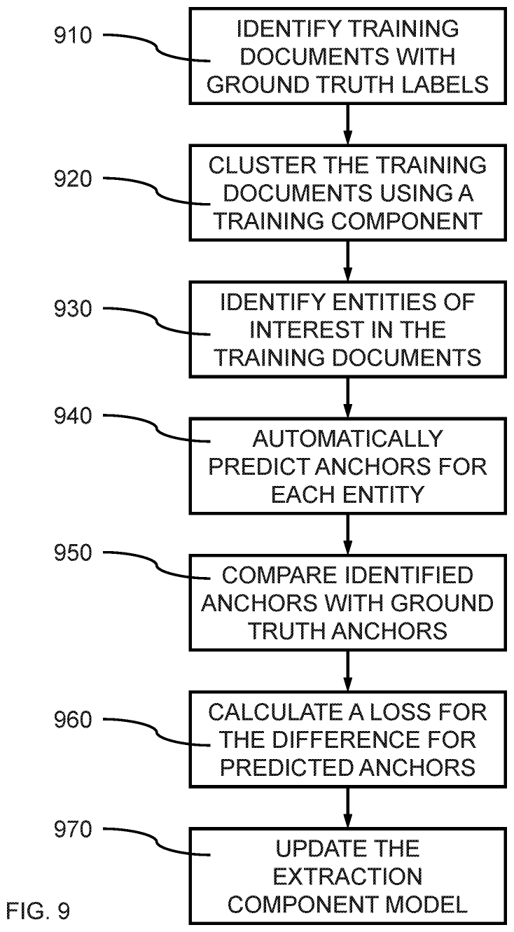

FIG. 9 shows an illustrative depiction of a method of training a extraction component model, according to aspects of the present disclosure.

At operation 910, a set of training documents can be identified, where the training documents include ground truth flexible anchor elements for training an anchor identifier model based on a neural network. The plurality of training documents can have different formats and fields, where the documents are labeled for training the anchor identifier model. A training component can identify training documents with ground truth labels.

At operation 920, the training documents can be clustered based on format and usage, where the documents can include labels indicating ground truth categories for clustering. A training component can cluster the training documents.

At operation 930, information elements can be identified in the training documents, where the information elements can be pre-identified and labeled in the training documents to specify the data fields to be associated with predicted anchors. An anchor identifier model can be trained to predict one or more flexible anchor elements to be associated with the predetermined information elements. A training component can identify entities of interest in the training documents.

At operation 940, the anchor identifier model can predict flexible anchor elements to be associated with the identified information elements, where the predicted anchors are based on one or more learnable metrics. The parameters of the anchor identifier model can adapt weight parameters for the learned metrics. A training component can automatically predict anchors for each entity.

At operation 950, the predicted anchors can be compared to the ground truth anchors of the training documents. A training component can compare identified anchors with ground truth anchors of the training documents. The difference between prediction and ground truth can indicate a discrepancy between extracted data and training data intended to be used to calculate insights.

At operation 960, a loss function can be calculated for the comparison of the predicted values to the ground truth values. A training component can calculate a loss for the difference for predicted anchors to the ground truth values.

At operation 970, the parameters of the extraction component model can be updated based on the loss function calculations to reduce the discrepancy between the ground truth anchors and the predicted anchors. The anchor identifier model can be further trained to further reduce the calculated errors. A training component can update the anchor identification model based on the loss.

FIG. 10 shows an example of a computer system, according to aspects of the present disclosure.

In an aspect, the computer device 1000 includes processor(s) 1010, memory subsystem 1020, communication interface 1050, I/O interface 1040, user interface component(s) 1060, and channel 1030. In various embodiments, a computer device 1000 can be configured to perform the operations described above and illustrated in FIG. 1-9.

In some embodiments, computing device 1000 is an example of, or includes aspects of, data extractor 200 (or data extraction apparatus) of FIG. 2. In some embodiments, computing device 1000 includes one or more processors 1010 that can execute instructions stored in memory subsystem 1020 for identifying flexible anchors in a document; associating information elements with the anchor(s); and extracting data for the information elements for analysis and calculations, where the data includes attributes corresponding to the information elements.

According to some aspects, computing device 1000 includes one or more processors 1010. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor 1010 is configured to operate a memory array using a memory controller. In other cases, a memory controller is integrated into a processor 1010. In some cases, a processor 1010 is configured to execute computer-readable instructions stored in a memory to perform various functions. In some embodiments, a processor 1010 includes special-purpose components for modem processing, baseband processing, digital signal processing, or transmission processing.

According to some aspects, memory subsystem 1020 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory subsystem 1020 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1050 operates at a boundary between communicating entities (such as computing device 1000, one or more user devices, a cloud, and one or more databases) and channel 1030 (e.g., bus) and can record and process communications. In some cases, communication interface 1050 is provided to enable a processing system coupled to a transceiver (e.g., a transmitter and/or a receiver). In some examples, the transceiver is configured to transmit (or send) and receive signals for a communications device via an antenna.

According to some aspects, user interface component(s) 1060 enable a user to interact with computing device 1000. In some cases, user interface component(s) 1060 include an audio device, such as an external speaker system, an external display device such as a display screen, an input device (e.g., a remote control device interfaced with a user interface directly or through the I/O controller), or a combination thereof. In some cases, user interface component(s) 1060 include a GUI.

According to some aspects, I/O interface 1040 is controlled by an I/O controller to manage input and output signals for computing device 1000. In some cases, I/O interface 1040 manages peripherals not integrated into computing device 1000. In some cases, I/O interface 1040 represents a physical connection or a port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a user interface component(s) 1060, including, but not limited to, a modem, a keyboard, a mouse, a touchscreen, or a similar device. In some cases, the I/O controller is implemented as a component of a processor. In some cases, a user interacts with a device via I/O interface 1040 or via hardware components controlled by the I/O controller.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a document and a query;
identifying, from the document, a plurality of data elements based on the query by locating a plurality of flexible anchor elements corresponding to the plurality of data elements, respectively;
extracting the plurality of data elements corresponding to the query based on the plurality of flexible anchor elements; and
generating content including an analysis of the extracted data elements based on the query.

2. The method of claim 1, wherein the content comprises a table containing the plurality of data elements.

3. The method of claim 1, wherein:
the content is generated in-situ within a software application that extracts the plurality of data elements.

4. The method of claim 1, wherein:
the content is generated by a generative machine learning model.

5. The method of claim 1, further comprising:
generating an additional document corresponding to the document based on the generated content.

6. The method of claim 1, further comprising:
generating an insight from the analysis, and
presenting the insight to a user.

7. The method of claim 1, wherein:
each of the flexible anchor elements comprises a plurality of relationships to a corresponding data element of the plurality of data elements.

8. The method of claim 1, wherein:
the query is a natural language query interpreted by a natural language processing (NLP) model.

9. The method of claim 8, wherein:
the NLP model is a Bidirectional Encoder Representations from Transformers (BERT) or Generative pre-trained transformers (GPT) model.

10. A non-transitory computer-readable medium storing executable instructions,
which when executed by a processing device, cause the processing device to perform operations comprising:
obtaining a document and a query;
identifying, from the document, a plurality of data elements based on the query using a plurality of flexible anchor elements, respectively;
extracting the plurality of data elements corresponding to the query based on the plurality of flexible anchor elements; and
generating content including an analysis of the extracted data elements based on the query.

11. The non-transitory computer-readable medium of claim 10, wherein the executable instructions further cause the processing device to perform operations comprising:
presenting a generated insight to a user based on the content.

12. The non-transitory computer-readable medium of claim 10, wherein the executable instructions further cause the processing device to perform operations comprising:
inputting the one or more extracted data elements into a flat table having a denormalized schema.

13. The non-transitory computer-readable medium of claim 10, wherein the executable instructions further cause the processing device to perform operations comprising:
receiving a natural language query from a user, and
identifying the one or more data elements in at least one of the plurality of documents based on the query.

14. The non-transitory computer-readable medium of claim 13, wherein the executable instructions further cause the processing device to perform operations comprising:
parse the natural language query using a Bidirectional Encoder Representations from Transformers (BERT) or Generative pre-trained transformers (GPT) model.

15. A system, comprising:
a memory component; and
one or more processing devices coupled to the memory component, wherein the one or more processing devices are configured to perform operations comprising:
obtaining a document and a query;
identifying, from the document, a plurality of data elements based on the query using a plurality of flexible anchor elements, respectively;
extracting the plurality of data elements corresponding to the query based on the plurality of flexible anchor elements; and
generating content including an analysis of the extracted data elements based on the query.

16. The system of claim 15, further comprising:
clustering a plurality of documents to obtain a document cluster, wherein the plurality of data elements are obtained from the document cluster.

17. The system of claim 16, wherein:
the plurality of documents includes unstructured documents.

18. The system of claim 17, further comprising:
receiving the document and the query from a user;
analyzing the query using a natural language processor; and
generating an insight in response to the query based on the analysis.

19. The system of claim 18, further comprising:
an analysis model trained to automatically perform the analysis and generate the insight.

20. The system of claim 19, wherein:
at least one data element of the plurality of data elements is identified using a machine learning model trained to identify the at least one data element.
